(19) United States
(12) Patent Application Publication
(10) Pub. No.: US 2025/0069775 A1
(43) Pub. Date: Feb. 27, 2025

(54) DATA AND POWER CABLE ASSEMBLIES

(71) Applicant: Intuitive Surgical Operations, Inc., Sunnyvale, CA (US)

(72) Inventor: Andrew Waterbury, New Canaan, CA (US)

(73) Assignee: Intuitive Surgical Operations, Inc., Sunnyvale, CA (US)

(21) Appl. No.: 18/810,883

(22) Filed: Aug. 21, 2024

Related U.S. Application Data
(60) Provisional application No. 63/533,781, filed on Aug. 21, 2023.

(51) Int. Cl. H01B 7/04; B25J 19/00; H01B 1/02; H01B 7/00; H01B 7/40; H01B 9/00; H01B 11/22

(52) U.S. Cl. CPC H01B 7/041; B25J 19/0025; H01B 1/026; H01B 7/0045; H01B 7/40; H01B 9/003; H01B 9/005; H01B 11/22

(57) ABSTRACT

A data cable assembly and a power cable assembly. The data cable assembly including a first power cable and a first ground cable each including a plurality of cladded wires. The data cable assembly further including an data transmission cable and, in some instances, a clocking cable. The data transmission cable can be an active optical cable including, at each of its ends, an electrical-optical configured to covert received electrical signals to optical signals and convert received optical signals to electrical signals. The power cable assembly including a first, second, and third high power cable and a first, second, and third high power grounding cable, where each of the cables of the power cable assembly includes a plurality of cladded wires.

### CROSS-REFERENCE TO RELATED APPLICATIONS

This patent application claims the benefit of priority under 35 U.S.C. § 119 (e) to U.S. Provisional Patent Application Ser. No. 63/533,781, filed on Aug. 21, 2023, which is hereby incorporated by reference herein in its entirety.

### FIELD

The present disclosure is directed to systems and apparatuses for supplying power and data to distal components.

### BACKGROUND

Power, in the form of electrical current, and data, usually in the form of electromagnetic signals, can be transferred from a source to a receiving destination using a tethered channel (i.e., not wireless) such as a metallic wire (e.g., copper wire) or optical fiber. For example, a cable assembly having one or more cables may be used to transmit control signals (i.e., data) from a controller to a receiver. Electromagnetic signals associated with data communication may include a voltage (i.e., potential) that may be discretized or continuous (i.e., analog) and pulses of infrared or visible light. Tethered channels, such as cable assemblies, extending between two locations may be disposed, or otherwise experience movement or motion, in such a way as to impart stress on the tethered channel. A tethered channel subjected to stress can be damaged or broken ultimately resulting in a failure to transfer power and/or data.

### SUMMARY

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In general, in one aspect, embodiments relate to a data cable assembly including a first active optical cable, a first power cable including a first plurality of cladded wires, a first ground cable including a second plurality of cladded wires, and possibly a clocking cable.

In general, in one aspect, embodiments relate to a data cable assembly including a first power cable and a first ground cable forming a first pair, a second power cable and a second ground cable forming a second pair, a third power cable and a second ground cable forming a third pair, and a fourth power cable and a fourth ground cable forming a fourth pair. The data cable assembly further includes a data transmission cable such as an active optical cable. In some implementations, the data cable assembly further includes a clocking cable. In the data cable assembly each of the first, second, third, and fourth power cables and each of the first, second, third, and fourth ground cables comprises a plurality of cladded wires. Further, every cable in the data cable assembly is disposed on a plane such that a cross-sectional profile of the data cable assembly is rectangular or ribbed. Finally, the active optical cable and, where applicable, the clocking cable bound a center of the data cable assembly and the first and second pair are disposed adjacent to the active optical cable and the third and fourth pair are disposed adjacent to the clocking cable.

In general, in one aspect, embodiments relate to a data cable assembly including a data transmission cable such as an active optical cable disposed at an axial center of the data cable assembly. The data cable assembly further includes a flexible filler layer forming an annulus and disposed concentrically about the data transmission cable and a ring of cables disposed concentrically about the flexible filler layer. The ring of cables includes a first, second, third, and fourth power cable, a first, second, third, and fourth ground cable, where each of the first, second, third, and fourth power cables and each of the first, second, third, and fourth ground cables includes a plurality of cladded wires.

In general, in one aspect, embodiments relate to a power cable assembly including a first high power cable including a first plurality of cladded wires and a first high power grounding cable including a second plurality of cladded wires.

In general, in one aspect, embodiments relate to a robotic arm, including a base, a master control board, a power source, a first joint connected to the base, and a first link where a proximal end of the first link is connected to the first joint. The robotic arm further includes a first control board configured to control the first joint and a first power terminal disposed in one of the first link and the first joint. The robotic arm further includes a first data cable assembly including data transmission cable such as an active optical cable, a first power cable including a first plurality of cladded wires, and a first ground cable including a second plurality of cladded wires. The robotic arm further includes a first power cable assembly including a first high power cable including a third plurality of cladded wires and a first high power grounding cable including a fourth plurality of cladded wires. In the robotic arm, a proximal end of the first data cable assembly is communicatively connected to the master control board, the first data cable assembly passing through the first joint with a distal end of the first data cable assembly communicatively connected to the first control board. Further, in the robotic arm, a proximal end of the first power cable assembly is electrically connected to the power source, the first power cable assembly passing through the first joint with a distal end of the first power cable assembly electrically connected to the first power terminal.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts an example wiring harness having two cable assemblies, each including two more cables, in accordance with one or more embodiments.

FIG. 2 depicts a bend in a wire in accordance with one or more embodiments.

FIG. 3 depicts a strength-N cycles plot in accordance with one or more embodiments.

FIG. 4 depicts a robotic arm in accordance with one or more embodiments.

FIG. 5 depicts a simplified schematic of a robotic arm in accordance with one or more embodiments.

FIG. 6 depicts a power cable assembly in accordance with one or more embodiments.

FIG. 7 depicts a data cable assembly in accordance with one or more embodiments.

FIG. 8 depicts a data cable assembly in accordance with one or more embodiments.

FIG. 9A depicts a data cable assembly connected to a control board with a connector in accordance with one or more embodiments.

FIG. 9B depicts a sectional view of the connector of FIG. 9B.

### DETAILED DESCRIPTION

In the following description, specific details are set forth describing some embodiments consistent with the present disclosure. Numerous specific details are set forth in order to provide a thorough understanding of the embodiments. It will be apparent, however, to one skilled in the art that some embodiments can be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In some instances, well known methods, procedures, components, and circuits have not been described in detail so as not to unnecessarily obscure aspects of the embodiments. For example, devices and substitutes that provide or enable linear actuation, such as pneumatic cylinders and lead screws are well understood without detailed descriptions of aspects of such devices like gaskets, thread pitch, etc. Thus, specific descriptions regarding such devices, procedures, components, and how circuits can be integrated with, or used within, embodiments of the instant disclosure are omitted herein for concision where applicable without causing undue ambiguity or uncertainty.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element can encompass more than one element and succeed (or precede) the second element in an ordering of elements.

It is to be understood that the singular forms “a,” “an,” and “the” include plural referents unless the context clearly dictates otherwise. Thus, for example, reference to “a strand” includes reference to one or more of such strands.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

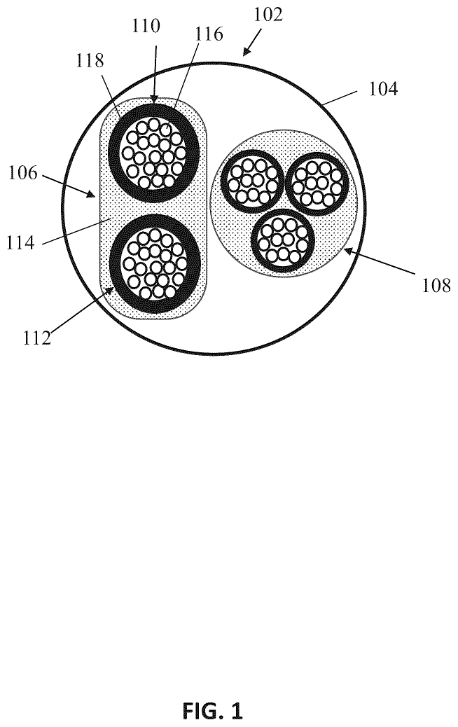

In the following description of FIGS. 1-9, any component described with regard to a figure, in various embodiments disclosed herein, may be equivalent to one or more like-named components described with regard to any other figure. For brevity, descriptions of these components are not necessarily repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Considering the figures, specific non-limiting embodiments are described in further detail. It should be understood that the various systems, components, features, and methods described relative to these embodiments can be used either individually and/or in any desired combination as the disclosure is not limited to only the specific embodiments described herein.

Power, in the form of electrical current, and data, usually in the form of electromagnetic signals, can be transferred between two locations using a tethered channel (i.e., not wireless). Various types of tethered channels exist, including but not limited to: wires; cables; fiber strands; cable assemblies; and wiring harnesses. Often, the distinction between types of tethered channels is convoluted. For example, in the literature the terms “cable assembly” and “wiring harness” are often interchanged or used synonymously. For consistency, the instant disclosure defines a nomenclature and hierarchical relationship between types of tethered channels. However, one skilled in the art will recognize that the concepts and apparatuses detailed hereafter are not limited by this choice of nomenclature.

FIG. 1 depicts a cross-sectional view of a wiring harness (102). A wiring harness (102), as defined herein, consists of one or more cable assemblies. As such, a wiring harness (102) includes an exterior covering (104), or sheath, that, at the very least, maintains the one or more cable assemblies in close proximity. In some instances, the exterior covering (104) may protect the internally disposed cable assemblies from environmental threats such as heat, moisture, and sharp objects. There is no limitation on the physical shape or profile to which a wiring harness may conform. The wiring harness (102) of FIG. 1 is depicted as having a substantially circular cross-sectional profile, however, in general, the cross-sectional profile of a wiring harness (102) may be rectangular or some other shape.

The wiring harness (102) of FIG. 1 encloses two cable assemblies, namely, a first cable assembly (106) and a second cable assembly (108). A cable assembly, as defined herein, consists of one or more cables. Similar to the wiring harness (102), the cross-sectional profile of a cable assembly may approximate any number of shapes. For example, in FIG. 1, the cross-sectional profile of the first cable assembly (106) is approximately rectangular while the cross-sectional profile of the second cable assembly (108) is substantially circular. In FIG. 1, the first cable assembly (106) includes two cables; a first cable (110) and a second cable (112). The second cable assembly (108) of FIG. 1 consists of three cables. For concision, the three cables of the second cable assembly (108), and their circumscribed elements, are not given explicit labels.

A cable assembly contains its associated one or more cables with a cable jacket (114). A cable jacket (114) surrounds the cable(s) in a cable assembly, typically providing the cable(s) protection from heat (e.g., flames), moisture, chemicals (e.g., oil), light (e.g., sunlight, ultraviolet rays, etc.), and physical impact (e.g., abrasion). Generally, a cable jacket (114) is made from a damage-resistant material such as a thermoplastic or thermosetting material. Common types of cable jacket (114) materials include, but are not limited to: polyvinyl chloride (PVC); polyurethane; ethylene propylene rubber (EPR); and neoprene. Further, and perhaps in contrast to a wiring harness (102), a cable assembly often binds together, through use of the cable jacket (114), its one or more cables such that the cable assembly behaves as a single cable (i.e., enclosed cables bend and move together without much, if any, relative displacement between cables).

A cable (e.g., first cable (110), second cable (112)) encompasses two or more strands. To avoid unnecessarily cluttering FIG. 1, only a single strand (116) is annotated in FIG. 1. A strand is a single filament. A strand can be made of metal, plastic, or glass. In the case of a metal strand, the strand may be referred to as a wire. Similarly, in the case of a glass or plastic strand, the strand may be referred to as a fiber or fiber strand. In forming a cable, the strands may be braided or twisted. Strands are generally sized according to a gauge, where smaller gauges correspond to increased strand thickness or diameter. Cables, likewise, may be categorized or otherwise characterized according to a gauge (or effective gauge). Because a cable consists of two or more strands, there will often be gaps or dead space between strands of a cable. The gauge and configuration of strands within a cable affect, among other things, the current capacity and flexibility of the cable. As such, in some instances, the gauge of a cable may correspond more with a current capacity than thickness such that a cable may be specified according to a required current capacity without regard for the configuration of the internal strands.

A cable, or rather the aggregation of its two or more strands, may be wrapped in insulation. For example, the insulation (118) of the first cable (110) is annotated in FIG. 1. Generally, the insulation (118) of a cable is made of a non-conductive material. Insulation (118) can also serve to preserve the material integrity of cable from environmental factors as previously described (e.g., heat, impact, moisture, etc.). In many instances, insulation (118) is characterized according to it dielectric strength, where dielectric strength is a measure (or indication) of the insulator's ability to withstand inducing a current in the presence of a potential gradient (i.e., a voltage applied across or through the insulation). Insulation (118) is often made of a plastic, fluoropolymer, or rubber material. Insulation (118) materials include, but are not limited to: polypropylene (PP); polyethylene (PE); polyvinyl chloride (PVC); polycarbonate (PC); perfluoroalkoxy (PFA); fluorinated ethylene propylene (FEP); ethylene tetrafluoroethylene copolymer (ETFE); and polytetrafluoroethylene (PTFE). The various materials for insulation (118) each have unique properties and characteristics, such as dielectric strength and mechanical strength, both of which may be sensitive to, or a function of, temperature. As such, insulation (118) for a cable should be selected according to the expected environment (e.g., temperature range) and use conditions. In some instances, insulation (118) may also include a wire mesh, coil, or other metallic shield, and/or be constructed with more than one material, either mixed or disposed in concentric layers (i.e., cable insulation can be a composite material) in order to shield the strands of the cable from electromagnetic interference, prevent cross-talk between cables of a cable assembly (or wiring harness), and to prevent electrical leaks.

Hereafter, for simplicity, a tethered channel used to transfer power or data will be referred to as a cable unless otherwise noted. In general, cables (with any type of strand: metallic, glass, etc.) can be used to transmit voice messages, visual images, control signals, and other forms of data via electromagnetic signals such as a voltage or electromagnetic radiation (i.e., infrared light, visible light, radio waves, etc.). Cables are employed to enable communication and data transmission between many types of electronic devices such as computers and televisions.

Cables that supply an electric current to power a device may be referred to as power cables. Likewise, cables used as a medium for electromagnetic signals for the purpose of data transfer and/or communication may be referred to as data cables. The strands used in the power cables are often copper or aluminum (or alloys of copper or aluminum) due to the high electrical conductivity of these metals relative to other metals. Power cables can operate under, or be designed for, high voltages and large current loads. Power cables operate as either direct-current conductors or alternating current conductors (typically at low frequencies). Data cables, in contrast, typically operate under lower voltage and current loads (when transmitting electrical signals) but at higher frequencies.

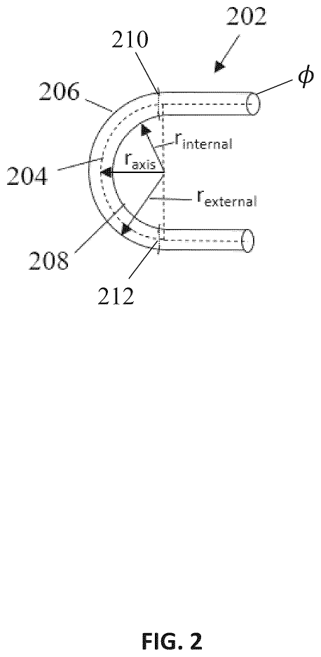

Cables can experience mechanical stresses (e.g., tensile stress, shear stress, etc.) when in use. Consequently, cables can become damaged or broken when subjected to high, prolonged, and/or frequent (e.g., cyclical) stress ultimately resulting in a failure to transfer power and/or data. For example, bending a cable exhibits tensile, compressive, and shear stresses (e.g., relative displacement of strands to insulation) on the cable and its components (i.e., strands and insulation). FIG. 2 depicts a single strand, or wire (202), undergoing a bend. The wire (202) has a diameter (ϕ). The wire (202) defines a neutral axis (204) that traverses the axial center of the wire (202). The bend of the wire (202) can be described according to a bend radius of the neutral axis (rₐₓᵢₛ). The wire (202) of FIG. 2 is also annotated with an external segment (206) bounded by a first termination line (210) and a second termination line (212). Additionally, the wire (202) of FIG. 2 is annotated with an internal segment (208), likewise bounded by the first termination line (210) and the second termination line (212). The external segment (206) and internal segment (208) are each associated with a bend radius; namely, the bend radius of the external segment (rₑₓₜₑᵣₙₐₗ) and the bend radius of the internal segment (rᵢₙₜₑᵣₙₐₗ), respectively. As seen in FIG. 2, due to the bend in the wire (202), the lengths of the external segment (206), internal segment (208), and a length of a segment along the neutral axis (204) similarly bounded by the first termination line (210) and the second termination line (212), are not the same. The length of any one of these segments may be given by

$${L}_{segment} = π {r}_{segment} , \qquad ( 1 )$$

where r_{segment} is equal to the bend radius associated with the segment (i.e., rₑₓₜₑᵣₙₐₗ, rₐₓᵢₛ, or rᵢₙₜₑᵣₙₐₗ). As such, Lᵢₙₜₑᵣₙₐₗ≤Lₐₓᵢₛ≤Lₑₓₜₑᵣₙₐₗ because rᵢₙₜₑᵣₙₐₗ≤rₐₓᵢₛ≤rₑₓₜₑᵣₙₐₗ. Because the referenced segments have different lengths but terminate at the same lines (i.e., first termination line (210) and the second termination line (212)) on the wire (202), this demonstrates that portions of the wire are stretched, and other portions compressed, in order to accommodate the bend. Stretched and compressed portions of the wire (202) will undergo tensile and compressive stress, respectively. An approximation of the tensile stress along the external segment, σₑₓₜₑᵣₙₐₗ, is

$${σ}_{external} = \frac{ϕ}{2} \frac{E}{{r}_{axis}} , \qquad ( 2 )$$

where ϕ is the diameter of the wire, rₐₓᵢₛ is the bend radius of the neutral axis, E is the modulus of elasticity of the wire (202). For the present case, the compressive stress along the internal segment (208) is equivalent in magnitude to the tensile stress (or, depending on the notation, σᵢₙₜₑᵣₙₐₗ=−σₑₓₜₑᵣₙₐₗ). Inspection of EQ. 2 reveals that the tensile and compressive stress imparted to a wire (202) is inversely proportional to the bend radius of the neutral axis (rₐₓᵢₛ). Thus, the “tighter” (i.e., smaller neutral axis bend radius) a bend in a wire (202), the greater the tensile and compressive force imparted to the wire (202).

Determining the distribution stresses (tensile, compressive, shear, etc.) along a cable (or cable assembly or wiring harness) is complex and the stress distribution cannot be approximated with an analytical expression like that of EQ. 2. The complexity is due, at least in part, to the inherently composite nature of cables or cable assemblies that can have multiple strands, cables, and insulators—each with their own modulus of elasticity and unique disposition relative to a neutral axis. Generally, the stress distribution of a cable or cable assembly can only be approximated using a computational simulation method, such as finite element analysis (FEA), or though empirical testing. A description of such methods and tests exceeds the scope of this disclosure. However, it is stated that, in general, stresses applied to a cable or cable assembly are inversely proportional (in magnitude) to the bend radius of a neutral axis of the cable or cable assembly. That is, as with the wire (202), the tighter the bend (or the smaller the bend radius of a neutral axis) in a cable or cable assembly, the greater the stresses imparted to the cable or cable assembly.

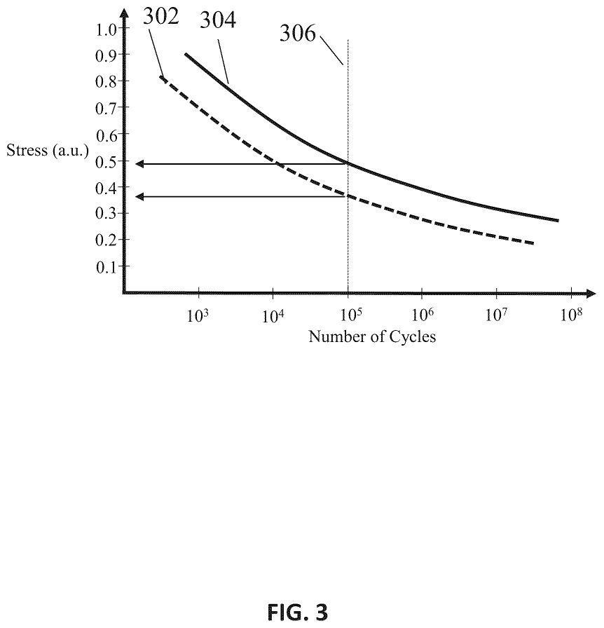

Fatigue strength is defined as the maximum value of completely reversed bending stress that a material can withstand for a specified number of cycles without fatigue failure. FIG. 3 depicts a fictional strength-N cycles plot. While fictional (i.e., not necessarily representative of any specified material), the plot is illustrative of typical fatigue strength behavior. The ordinate axis of the strength-N cycles plot of FIG. 3 represents a value of stress. In the case of FIG. 3, the stress is given in normalized arbitrary units (a.u.). The abscissa axis represents a number of reversed bending cycles applied to a material. Thus, a strength-N cycles plot indicates the number of cycles a material may withstand before failure at a given stress. FIG. 3 depicts a first curve (302) representative of the strength-N cycles behavior of a first material as well as a second curve (304) representative of the strength-N cycles behavior of a second material. As seen in FIG. 3, the general trend is that if a material is subjected to a lower reversible bending stress, then that material can undergo more cycles before failure. In some instances, it may be desirable for a material to endure a fixed number of cycles, for example, representative of the expected life, or serviceable life, of a mechanical part or equipment item. FIG. 3 depicts an example number of cycles requirement (306) of 100,000 cycles. As seen, in FIG. 3, the second material can achieve the example number of cycles requirement (306) while experiencing a higher stress than the second material.

Cables may be disposed within, or be otherwise configured to move with, maneuverable mechanical parts, where movement can include translation, rotation, oscillation, etc. Consequently, a cable can be subjected to loading cycles where stress is applied, released, and sometime reversed. Generally, cables (and cable assemblies and wiring harnesses) exhibit fatigue strength behavior similar to the curves depicted in FIG. 3. That is, cables subjected to lower reversible bending stresses can undergo more cycles before failure. Increasingly, cables associated with equipment items that experience movement are required to undertake smaller bend radii and are subsequently subjected to higher values of stress. Further, it is desirable for cables (and cable assemblies and wiring harnesses) to outlast (i.e., go without failure) the lifetime, or serviceable lifetime, of it associated equipment item defined, or at least approximated by, a number of cycles requirement. Accordingly, there exists a need for cables (and cable assemblies and wiring harnesses) with increased fatigue strength.

Embodiments disclosed herein relate to the construction of cables and cable assemblies with increased fatigue strength suitable for applications where the cables and cable assemblies will frequently (e.g., cyclically) experience small bend radii. While embodiments of cables and cable assemblies disclosed herein will generally described in the context of use in robotic arms, one with ordinary skill in the art will recognize that this context does not impose a limitation on the instant disclosure. In general, the cables and cable assemblies described herein can be used or outfitted with any equipment item or as a means for transferring power and/or data between any two locations (e.g., a controller and receiver or a power source and a motor). Specific embodiments of cables and cable assemblies with increased fatigue strength suitable for application where the cables or cable assemblies will experience small bend radii are described in greater below.

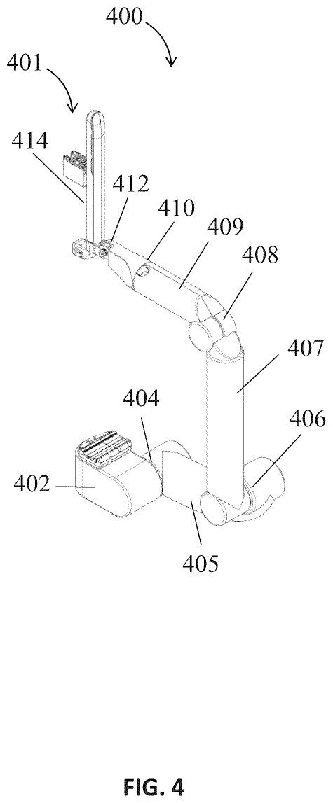

FIG. 4 depicts an example robotic arm (400). The example robotic arm (400) of FIG. 4 includes a base (402). The base (402) can be attached to a larger robotic assembly or other attachment location such as a rail or overhead mount. Typically, the base (402) is considered fixed in space during operation of the robotic arm (400) such that operation of the robotic arm (400) may be said to affect the position of a distal end (401) of the robotic arm (400) relative to the base (402). In other words, the robotic arm (400) can include a number of degrees of freedom between the base (402) and the distal end (401). The distal end (401) can be configured for the attachment of a tool. Herein, the term “tool” encompasses both general or industrial robotic tools and specialized robotic surgical instruments. Often, specialized robotic surgical instruments include a so-called “end effector” that is suitable for manipulation of tissue, treatment of tissue, imaging of tissue, or the like. For example, the end effector may be an actuatable gripping device. Attachment of a tool can be provided on the distal end (401) of the robotic arm (400) through a quick-disconnect coupling or tool holder. Actuation of the end effector can be controlled by the robotic arm (400) upon attachment of the tool.

As stated, operation of the robotic arm (400) includes control of the position of the distal end (401) and/or a tool and end effector attached thereon relative to the base (402). Herein, the term “position” encompasses both location and orientation (e.g., translation and rotation). The robotic arm (400) consists of a sequence of joints and links that move in coordination forming a kinematic configuration that determines the position of the distal end (401) and associated tool, if present. The robotic arm (400) of FIG. 4 has at least six joints annotated as the first joint (404), second joint (406), third joint (408), fourth joint (410), fifth joint (412), and sixth joint (414). In some instances, joints are connected by links. The robotic arm (400) of FIG. 4 has three links annotated as the first link (405), second link (407), and third link (409). Generally, links provide a spatial separation between joints and introduce a greater range of motion to the robotic arm (400). Joints can be rotary or prismatic. Joints may further be said to include a control board and a joint actuator, the joint actuator including all necessary components for operating and stopping the joint. For example, a joint actuator can include a motor, an encoder, gears, and/or a brake.

The term “state” of a joint or the like will herein refer to the control variables associated with the joint. For example, the state of a rotary joint can include an angle of the joint relative to an angular datum of the joint. Thus, the orientation of a rotary joint is known given its state or current angle. The state of a joint can further include the velocity (e.g., angular velocity) at which the joint is moving. Similarly, the state of an axial or prismatic joint may refer to the joint's axial position, and/or to its axial velocity. The control board of a joint can specify and determine the state of joint, where variations of the robotic arm (400) may rely primarily or entirely on position controllers, acceleration controllers, or the like. Hence, movements of the joints and movements of an end effector, tool, and/or distal end (401) of the robotic arm (400) described herein may be performed using a position control algorithm, a velocity control algorithm, a combination of both, and/or the like.

Thus, the kinematic configuration of the robotic arm (400) is completely specified through the state of the joints in view of the relative positions and lengths/sizes of the intervening links, if any. Operation of the robotic arm (400), which primarily consists of controlling the robotic arm (400) through a continuous space of joint states, is governed by a master control board. In some instances, the master control board resides within the robotic arm (400), for example, in the base (402). However, the master control board can be external to the robotic arm (400) (e.g., part of an externally disposed computer or control system).

The master control board may perform at least some of the calculations to determine the kinematic configuration of the robotic arm (400) and the sequence and timing of joint states that should be undertaken to achieve a desired kinematic configuration. Often, there will be many potential sequences of joint states that can achieve a desired kinematic configuration such that the master control board may also apply a constrained optimization routine to select a sequence of joint states (or select a path of traversal through a space of joint states) that is safe (i.e., avoids collisions between joints and links of the robotic arm (400)) while optimizing some predefined criterion/criteria (e.g., a minimum length path through the space of joint states, maximizing the range of motion of all available joints upon achieving the desired kinematic configuration, etc.).

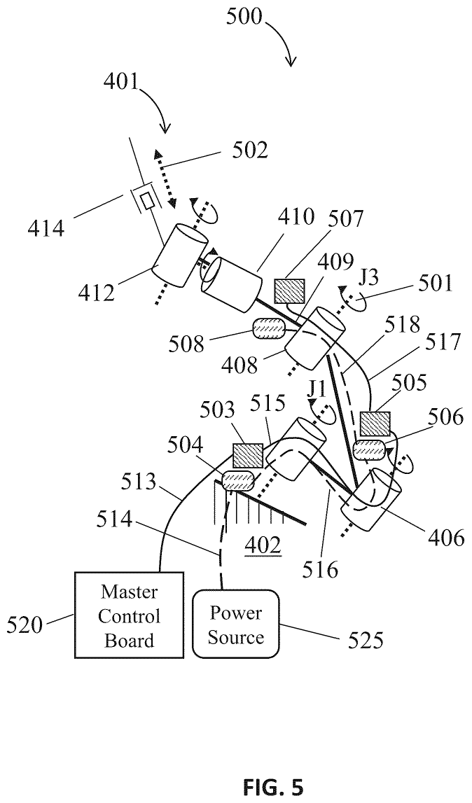

FIG. 5 depicts a simplified schematic view (500) of the example robotic arm (400) of FIG. 4. In the simplified schematic view (500), rotary joints are represented as cylinders, prismatic joints are represented as dampers, and link are represented as solid straight lines. Further, the simplified schematic view (500) illustrates an axis of rotation (501) or axis of translation (502) for each joint. To avoid cluttering FIG. 5, while all axes of rotation and translation are illustrated, not all are labelled.

As seen in FIG. 5, the first joint (404) is directly connected to the base (402). The first link (405) extends distally from the first joint (404) and rotates about a first pivotal joint axis (J1). The remaining joint axes, or axes of rotation and axes of translation can be identified by their associated joint. That is, the joint axis associated with the first joint (404) is J1, the joint axis associated with the second joint (406) is J2, and so on and so forth. As such, not every joint axis is labeled with a joint identifier (e.g., “J2”) in FIG. 5 to prevent unnecessarily cluttering the figure. Continuing, a distal end of the first link (405) is coupled to a proximal end of the second link (407) by the second joint (406) defining a second pivotal joint axis (J2). A proximal end of the third link (409) is coupled to the distal end of the second link (407) by the third joint (408) that defines a constrained pivotal joint axis (J3). A distal end of the third link (409) is coupled to the fourth joint (410), which is roll joint, so that all elements distal to the fourth joint (410) roll about a fourth joint axis (J4) that is coaxial to the third link (409). Proceeding distally, the fifth joint (412) is directly coupled to the fourth joint (410) and defines another constrained pivotal joint axis (J5). Finally, the sixth joint (414) is coupled to a distal end of the fifth joint (412), the sixth joint (414) defining a translation or prismatic axis (J6) along which the sixth joint (414) or attached tool can extend and contract.

The joints of the robotic arm (400) receive electrical power and command signals that, at least initially, originate from a power source (525) and master control board (520). Again, each of the power source (525) and master control board (520) may be located within (e.g., in the base (402)), or otherwise be considered part of, the robotic arm (400) or may be disposed externally to the robotic arm (400).

In accordance with one or more embodiments, power is transmitted to each joint (and other equipment items requiring electrical power such as an attached tool and/or sensor (e.g., a camera)) through a serial sequence of power cable assemblies and intervening power terminals. FIG. 5 depicts a first power terminal (504), second power terminal (506), and third power terminal (508) that are associated with the first joint (404), second joint (406), and third joint (408), respectively. The robotic arm can include additional power terminals, for example, associated with the fourth joint (410), the fifth joint (412), an attached tool, or other power-consuming equipment item of the robotic arm. However, for concision, additional power terminals are not represented in FIG. 5. In general, a power terminal can be disposed within a joint, or proximal to a joint (e.g., within a link). Further, there is no limitation on where within a joint or link a power terminal must be located (e.g., a proximal or a distal side) and more than one power terminal can be disposed within a single joint or link. One with ordinary skill in the art will appreciate that the intended purpose of depicting power terminals in FIG. 5 is to demonstrate that electrical power is provided throughout the robotic arm (400) though a serial sequence of power cable assemblies. As such, the power terminals may be depicted as abstract elements and without an exact specification of their disposition, without departing from the scope of the instant disclosure. Further, one of ordinary skill in the art will recognize that the disposition of the power terminals throughout a robotic arm is highly dependent on the configuration and mechanical structure of the robotic arm such that the abstract nature of the depiction of the power terminals in FIG. 5 is intended to be purposefully non-limiting. FIG. 5 depicts a first power cable assembly (514) that extends from the power source (525) to a first power terminal (504). Likewise, FIG. 5 depicts a second power cable assembly (516) that extends from the first power terminal (504) through, at least, the first joint (404) to a second power terminal (506). Finally, FIG. 5 depicts a third power cable assembly (518) that connects the second power terminal (506) and the third power terminal (508) while passing through, or otherwise traversing, the third joint (408). As such, to provide power to a distal joint and/or other equipment item (e.g., an attached tool), one or more power cable assemblies may need to pass through, or otherwise traverse, one or more joints between the base (402) of the robotic arm (400) and the distal joint and/or other equipment item. Often, the movement and state of a joint imposes a bend in the power cable assembly that passes through it. Advancements in robotic joints, particularly a reduction in the physical size/profile of robotic joints, impose increasingly small bend radii on the power cable assemblies. As previously discussed, the stress applied to a cable assembly due to a bend is inversely related to the bend radius. Generally, higher stresses result in reduced fatigue strength of the cable assembly (i.e., the maximum number of cycles that can be applied without failure/break). As such, embodiments disclosed herein relate to a power cable assembly with increased fatigue strength suitable for applications where the power cable assembly will frequently (e.g., cyclically) experience small bend radii such as in a robotic arm while maintaining or extending the life of the robotic arm.

The power requirements of a robotic arm (400) can decrease incrementally while proceeding toward the distal end (401) of the robotic arm (400). This is because power is siphoned off and consumed and/or expended at/by joints and equipment items proximal to a given joint and/or power-consuming equipment item. As such, in one or more embodiments, the effective gauge of cables in the power cable assemblies increases from power cable assembly to power cable assembly while proceeding distally along the robotic arm (400). That is, if the effective gauge of each of the one or more cables contained in the first power cable assembly (514)) is g₁ and the effective gauge of each of the one or more cables contained in the second power cable assembly (516)) is g₂, and so on and so forth, then g₁≤g₂≤g₃≤ . . . ≤g_{N} for N power cable assemblies in the robotic arm (400).

In accordance with one or more embodiments, data (and, in some instances, also power) is transmitted to each joint (or control board associated with the joint) through a serial sequence of data cable assemblies and intervening control boards. FIG. 5 depicts a first control board (503), second control board (505), and third control board (507) that are associated with the first joint (404), second joint (406), and third joint (408), respectively. The robotic arm can include additional control boards, for example, associated with the fourth joint (410), the fifth joint (412), an attached tool, or other controllable equipment item of the robotic arm (400). However, for concision, additional control boards are not represented in FIG. 5. In general, a control board can be disposed within a joint, or proximal to a joint (e.g., within a link). Further, there is no limitation on where within a joint or link a control board must be located (e.g., a proximal or a distal side) and more than one control board can be disposed within a single joint or link. One with ordinary skill in the art will appreciate that the intended purpose of depicting control boards in FIG. 5 is to demonstrate that data and control signals are communicated through the robotic arm (400) using a serial sequence of data cable assemblies. As such, the control boards may be depicted as abstract elements and without an exact specification of their disposition, without departing from the scope of the instant disclosure. Further, one of ordinary skill in the art will recognize that the disposition of the control boards throughout a robotic arm is highly dependent on the configuration and mechanical structure of the robotic arm such that the abstract nature of the depiction of the control boards in FIG. 5 is intended to be purposefully non-limiting. FIG. 5 depicts a first data cable assembly (513) that extends from the master control board (520) to a first control board (503). Likewise, FIG. 5 depicts a second data cable assembly (515) that extends from the first control board (503) through, at least, the first joint (404) to a second control board (505). Finally, FIG. 5 depicts a third data cable assembly (517) that connects the second control board (505) and the third control board (507) while passing through, or otherwise traversing, the third joint (408). As such, to transfer data and control signals to a distal joint (or control board associated with the joint) and/or other equipment item (e.g., an attached tool), one or more data cable assemblies may need to pass through, or otherwise traverse, one or more joints between the base (402) of the robotic arm (400) and the distal joint and/or other equipment item. Often, the movement and state of a joint imposes a bend in the data cable assembly that passes through it. Advancements in robotic joints, particularly a reduction in the physical size/profile of robotic joints, impose increasingly small bend radii on the data cable assemblies. As previously discussed, the stress applied to a cable assembly due to a bend is inversely related to the bend radius. Generally, higher stresses result in reduced fatigue strength of the cable assembly (i.e., the maximum number of cycles that can be applied without failure/break). As such, embodiments disclosed herein relate to a data cable assembly with increased fatigue strength suitable for applications where the data cable assembly will frequently (e.g., cyclically) experience small bend radii such as in a robotic arm while maintaining or extending the life of the robotic arm.

It is noted that a control board (e.g., first control board (503)) and a power terminal (e.g., first power terminal (504)) need not be separate and/or distinct entities. For example, a control board may provide electrical power connections and act as a power terminal. Further, while FIG. 5 depicts instances of both a data cable assembly (e.g., first data cable assembly (513)) and power cable assembly (e.g., first power cable assembly (514)), instances of data and power cable assemblies may be bundled to form one or more wiring harnesses. Thus, a wiring harness may include a data cable assembly and a power cable assembly.

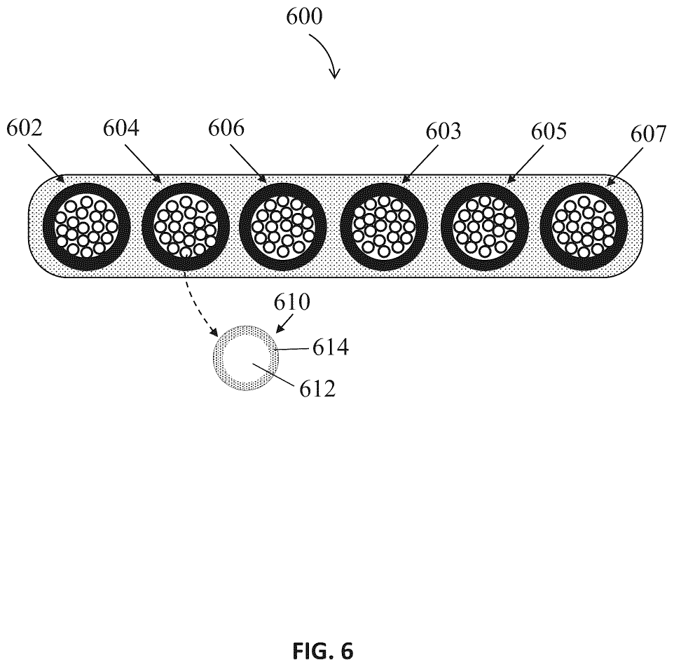

FIG. 6 depicts an embodiment of a power cable assembly (600). In the embodiment of FIG. 6, the power cable assembly (600) includes three high power cables and three high power grounding cables. In FIG. 6, the three high power cables are labelled as a first high power cable (602), a second high power cable (604), and a third high power cable (606). Similarly, the three high power grounding cables are labelled as a first high power grounding cable (603), a second high power grounding cable (605), and a third high power grounding cable (607). Herein, the term “high power” indicates that the cable, whether a high power cable or a high power grounding cable, is configured to accept a 48V potential and carry at least 3 Amps of electrical current.

Each of the cables, high power cables and high power grounding cables, in the power cable assembly (600) consists of a plurality of cladded wires. FIG. 6 further depicts an expanded view of a cladded wire (610). A cladded wire has a core (612) made from a first metal or first alloy enclosed by a shell (i.e., cladding) (614) made from a second metal or second alloy. A cladded wire is distinct from a plated or coated wire in that the shell is magnitudes thicker relative to the diameter of the core in a cladded wire when compared to a so-called plated or coated wire, where for the latter process the coating thickness is typically less than one micron and added for corrosion resistance or solderability. In a practical sense, plated wires are not diametrically different than before the plating process, whereas cladded wires are. In accordance with one or more embodiments, including the embodiment depicted in FIG. 6, a cladded wire is defined as a core-shell wire where the cross-sectional area ratio of the shell to the core exceeds 5%. Without limitation, the first metal (i.e., core (612)) can be nitinol (NiTi), steel, titanium, or tungsten. Further, the second metal (i.e., shell (614)) can be aluminum, gold, silver, platinum, or copper. Thus, the cladded wire (610) may be constructed of any combination of core (612) and shell (614) materials according to the aforementioned core materials and shell materials.

The cladded wire can be formed through any known cladding techniques, such as roll bonding, extrusion, deposition (e.g., laser cladding), direct welding (DIR), continuous welding (CW), or any other method known, or to be known, in the art. Notably, the cladded wire has a core-shell structure and is distinct, both in appearance and properties, from mixtures of materials (e.g., a core material such as tungsten and a shell material such as copper) such as metal matrix composites.

As stated, FIG. 6 depicts an embodiment of the power cable assembly (600). In this embodiment, the power cable assembly (600) contains three high power cables and three high power grounding cables, where each of the cables of the power cable assembly (600) includes a plurality of cladded wires. Thus, in one embodiment, the power cable assembly (600) consists of what is shown and no more. Further, and as depicted in FIG. 6, each cable included in the power cable assembly (600) may be insulated and the cables may be associated together as a cable assembly using a cable jacket.

In one or more embodiments, the power cable assembly carries 11 Amps total, distributed amongst its high power cables, under a 48V potential. For example, in the embodiment depicted in FIG. 6, the 11 Amps of current is distributed over the first high power cable (602), second high power cable (604), and third high power cable (606).

In some embodiments, with respect to the cladded wires, the core (612) is tungsten (or a tungsten alloy), and the shell (614) is copper (or a copper alloy). Hereafter, the cladded wire having a tungsten core and a copper shell will be referred to as a copper cladded tungsten (CCT) wire.

The electrical conductivity of copper is approximately 5.96×10⁷ (S/m at 20° C.). The electrical conductivity of tungsten is approximately 1.79×10⁷ (S/m at 20° C.). The yield strength of copper is approximately 70 MPa. The yield strength of tungsten is approximately 550 MPa. Note that measurements of yield strength of metals greatly vary based on purity and instrumentation and geometry. For example, finer gauge wire typically has increased tensile strength. However, the CCT wire derives strength, and thus greater fatigue strength, from its tungsten core while maintaining high electrical conductivity due it its copper shell.

An additional benefit of the copper cladded tungsten (CCT) wire is that the improved strength while maintaining high electrical conductivity allows for fewer wires, and thus smaller cables (i.e., higher gauge cables) to be employed in the power cable assembly, improving space efficiency (e.g., in a robotic arm) and further allowing or smaller bend radii.

In some embodiments, with respect to the cladded wires, the core (612) is steel (or a steel alloy), and the shell (614) is copper (or a copper alloy). Similar to the CCT wire, the copper cladded steel wire has improved strength while maintaining high electrical conductivity allowing for fewer wires, and thus smaller cables to be employed in the power cable assembly, improving space efficiency and further allowing for smaller bend radii.

In FIG. 6, the three high power cables are disposed adjacent to one another in the power cable assembly (600). Likewise, the three high power grounding cables are disposed adjacent to one another in the power cable assembly (600). However, the disposition of the cables in a power cable assembly is not limited to that shown in FIG. 6. For example, the cables can be disposed as a sequence of high power cable and high power grounding cable pairs. In one or more embodiments, each of the high power cables and high power grounding cables in the power cable assembly is a 16 American Wire Gauge (AWG) cable.

While FIG. 6 depicts the power cable assembly with an approximately “rectangular” cross-sectional profile, the power cable assembly is not limited to this cross-sectional profile. In general, the power cable assembly can be “flat” (like shown in FIG. 6), “round,” “ribbon,” or any other shape. Further, the power cable assembly can contain any number of additional high power cables and high power grounding cables without limitation. In one or more embodiments, the terminating ends of the cladded wires, or at least the terminating ends of the high power cables and high power grounding cables, are plated to enhance soldering to a power terminal. The plating material may be tin, copper, or gold.

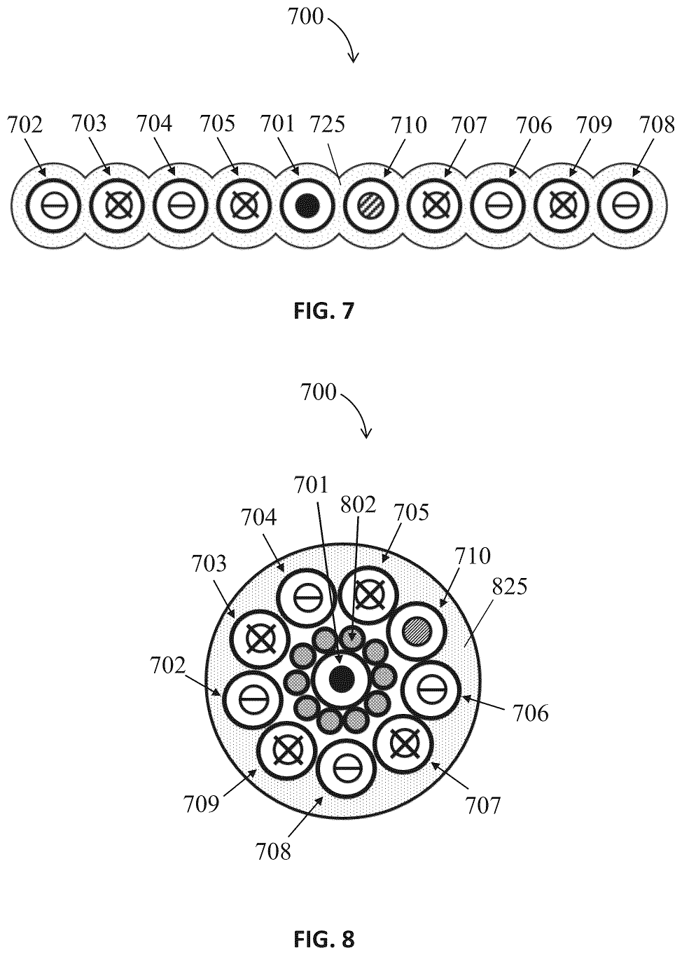

FIG. 7 depicts an embodiment of a data cable assembly (700). In general, a data cable assembly (700) includes at least two pairs of power and ground cables (i.e., a single pair includes one power cable and one ground cable), at least one data transmission cable (e.g., active optical cable (AOC)), and possibly a clocking cable (CC). That is, in some embodiments a clocking cable (CC) is omitted from the data cable assembly (700). In such cases, clocking functionality can be performed mechanically using connectors, described below. A clocking cable (CC) is responsible for conveying temporal information and enabling synchronization of connected devices (e.g., control boards). In some embodiments, the clocking cable (CC) is included in the data cable assembly (700) but is not used to convey temporal information. In some instances, where a clocking cable (CC) is included but not used for clocking functionality (e.g., clocking performed mechanically by the connectors), the clocking cable (CC) can be repurposed or used as a power or ground cable. In some embodiments, the clocking cable (CC) includes a plurality of cladded wires such as CCT wires. In other embodiments, the clocking cable (CC) is a fiber optic cable, or a cable having one or optical fibers, such as an AOC.

In one or more embodiments, the data transmission cable of the data cable assembly (700) is an active optical cable (AOC). An AOC is a cable that accepts and produces standard electrical signals at its terminating ends but actually propagates the signal through the cable using one or more optical fibers (i.e., a fiber optic cable). In general, an AOC consists of a fiber optic cable terminated with one or more electrical-optical converters on its ends. For example, a first electrical-optical converter can be disposed on a proximal end of the fiber optic cable of the AOC and a second electrical-optical converted can be disposed on a distal end of the fiber optic cable of the AOC. An electrical-optical converter, depending on its disposition, can convert an electrical signal to an optical signal, an optical signal to an electrical signal, or handle both electrical-to-optical conversion and optical-to-electrical conversion. Fiber optic cables generally have improved speed and distance performance over their metallic counterparts and can be made to be extremely thin.

In instances where the data cable assembly (700) includes two or more AOCs, data transmission through the data cable assembly (700) may be partitioned into transmission and reception tasks relative to one end of the data cable assembly (700). For example, if a data cable assembly (700) includes two AOCs, for example, a first AOC and a second AOC, then the first AOC may be considered a transmission cable while the second AOC may be considered a reception cable. In instances where the data cable assembly (700) includes only a single AOC, then both aspects of data transmission (i.e., transmission and reception) are handled by the single AOC.

In accordance with one or more embodiments, any AOC of the data cable assembly (700) has a transmission speed of at least 500 Mbps. Further, fiber optic cables can, in many instances, accommodate small bend radii and high stress cyclical loading. As such, AOCs make use of the improved performance of a fiber optic cable without sacrificing compatibility with standard electrical interfaces. In one or more embodiments, any and all AOCs used in the data cable assembly are configured for low-voltage differential signaling (LVDS), also known as the technical standard TIA/EIA-644, with a connection impedance between 90 and 100 ohms.

In some embodiments, the data transmission cable of the data cable assembly (700) is not an AOC but can be, for example, a cable constructed of twisted shield pairs with copper cladding. The cycle life of a twisted shield pair is expected to be improved compared to conventional cabling allowing for improved strength while maintaining high electrical conductivity allowing for fewer wires, and thus smaller cables to be employed in the data cable assembly (700), improving space efficiency and further allowing for smaller bend radii.

As stated, the data cable assembly includes at least two pairs of power and ground cables. Note that the power cable assembly, as previously described, used the terms high power cable and high power grounding cable. As such, the terms power cable and ground cable are used with respect to the data cable assembly without conflicting or sharing terminology between the power cable assembly and data cable assembly, as these assemblies are described herein. Returning to the data cable assembly, each power cable and each ground cable consists of a plurality of cladded wires.

Similar to the cladded wires of the power cable assembly, each cladded wire in the data cable assembly includes a core made from a third metal or third alloy enclosed by a shell made from a fourth metal or fourth alloy. Without limitation, the third metal can be nitinol (NiTi), steel, titanium, or tungsten. Further, the fourth metal can be aluminum, gold, silver, platinum, or copper. The cladded wires used in the data cable assembly may be constructed of any combination of third and fourth metals (or third and fourth alloys) according to the aforementioned core materials and shell materials. For example, in one or more embodiments, the core of each cladded wire used in the power and ground cables of the data cable assembly is steel (or a steel alloy) and the shell of each cladded wire used in the power and ground cables of the data cable assembly (700) is copper (or a copper alloy).

In one or more embodiments, the core of each cladded wire used in the power and ground cables of the data cable assembly is tungsten (or a tungsten alloy) and the shell of each cladded wire used in the power and ground cables of the data cable assembly (700) is copper (or a copper alloy). That is, in one or more embodiments, each cladded wire used in the data cable assembly is a copper cladded tungsten (CCT) wire.

In accordance with one or more embodiments, each power and ground cable used in the data cable assembly is configured to accept a 20V potential and carry 1.25 Amps of electrical current.

In general, the data cable assembly will include a cable jacket with a given cross-sectional profile. The cross-sectional profile of the data cable assembly (or rather its cable jacket) can be “flat,” “ribbon” (like that shown in FIG. 7), “round” (like that shown in FIG. 8), or any other shape. Further, the data cable assembly can contain any number of additional power cables, ground cables, AOCs, and clocking cables, without limitation.

In one embodiment, the data cable assembly includes a first and second power cable, a first and second ground cable, a data transmission cable (e.g., active optical cable), and a clocking cable. Thus, in this embodiment, the data cable assembly includes six distinct cables. In one or more embodiments where the data cable assembly consists of the six immediately mentioned cables, the data cable assembly is terminated with a USB type connector (e.g., a USB-C type connector). In some instances, for example, while using a data cable assembly to connect two control boards across a portion of robotic arm (e.g., through a joint), more than one data cable assembly may be used. For example, two of the described six-cable data cable assemblies can connect, in parallel, between two control boards.

As stated, FIG. 7 depicts a specific embodiment of the data cable assembly (700), as described herein. As seen in FIG. 7, this embodiment of the data cable assembly (700) includes four pairs of power and ground cables (labels specified below), a first active optical cable (AOC) (701), and a first clocking cable (CC) (710). That is, this embodiment of the data cable assembly (700) has a first power cable (703), a second power cable (705), a third power cable (707), a fourth power cable (709), a first ground cable (702), a second ground cable (704), a third ground cable (706), a fourth ground cable (708), a first AOC (701), and a clocking cable (710). Notably, variations of this specific embodiment are considered by the instant disclosure such as the use of twisted shield pairs in place of the AOC as a data transmission cable, the omission of the clocking cable, and/or the used of an included clocking cable as a power or ground cable.

In the embodiment of FIG. 7, the first power cable (703), the second power cable (705), the third power cable (707), the fourth power cable (709), the first ground cable (702), the second ground cable (704), the third ground cable (706), and the fourth ground cable (708) each include a plurality of cladded wires.

Further, in accordance with the embodiment depicted in FIG. 7, each of the four power cables (703, 705, 707, 709) is configured to accept a 20V potential and carry 1.25 Amps of electrical current such that the data cable assembly (700) of FIG. 7 can supply an aggregate total of 5 Amps.

As depicted in FIG. 7, the data cable assembly (700) includes a first cable jacket (725) that encloses and groups the cables of the data cable assembly (700), the first cable jacket (700) giving a cross-sectional profile of the data cable assembly (700) a “ribbon” shape. The “ribbon” shape may also be described as having a cross-sectional profile that is substantially “flat” or rectangular with a ribbed portion for each enclosed cable. In some instances, the cross-sectional profile of the data cable assembly (700) depicted in FIG. 7 may be describe as “ribbed.”

In one embodiment, the data cable assembly (700) depicted in FIG. 7 consists of what is shown and no more.

FIG. 8 depicts another embodiment of the data cable assembly. In FIG. 8, the data cable assembly has a substantially circular cross-sectional profile formed by a second cable jacket (825). As before, this embodiment of the data cable assembly (700) includes four pairs of power and ground cables, namely, a first power cable (703), a second power cable (705), a third power cable (707), a fourth power cable (709), a first ground cable (702), a second ground cable (704), a third ground cable (706), a fourth ground cable (708). This embodiment further includes a first active optical cable (AOC) (701) and a first clocking cable (CC) (710). Notably, variations of this specific embodiment are considered by the instant disclosure such as the use of twisted shield pairs in place of the AOC as a data transmission cable, the omission of the clocking cable, and/or the used of an included clocking cable as a power or ground cable.

In the embodiment of FIG. 8, the first power cable (703), the second power cable (705), the third power cable (707), the fourth power cable (709), the first ground cable (702), the second ground cable (704), the third ground cable (706), and the fourth ground cable (708) each include a plurality of cladded wires.

In the embodiment of FIG. 8, data transmission is handled by a single AOC (i.e., first AOC (701)) disposed at the axial center of the data cable assembly (700). In other embodiments, data transmission may be handled by a plurality of AOC cables disposed at the axial center of the data cable assembly (700). The single AOC cable or plurality of AOC cables includes one or more electrical-optical converters at each terminating end of the data cable assembly (700). In the embodiment depicted in FIG. 8, a flexible filler layer (813) is used to fill space in the data cable assembly (700) and organize the enclosed cables in concentric rings. In this way, the flexible filler layer (813) can prevent the enclosed cables from becoming internally tangled or “pinched” in the data cable assembly (700).

In accordance with the embodiment depicted in FIG. 8, each of the four power cables (703, 705, 707, 709) is configured to accept a 20V potential and carry 1.25 Amps of electrical current such that the data cable assembly of FIG. 8 can supply an aggregate total of 5 Amps.

In one embodiment, the data cable assembly (700) depicted in FIG. 8 consists of what is shown and no more.

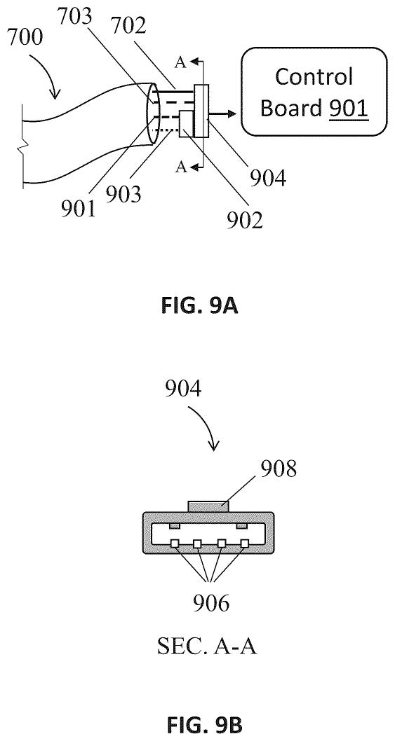

FIG. 9A depicts an expanded view of the connection of a data cable assembly (700) to a control board (901), in accordance with one or more embodiments. As seen in FIG. 9A, the data cable assembly (700) includes a first ground cable (702), a first power cable (703), and two data transmission cables as AOCs. Specifically the two data transmission cables as AOCs are referenced as a first reception cable (901) and a first transmission cable (903). For concision and to promote legibility of the figure, additional power and ground cables (e.g., second ground cable (704), second power cable (705)) and the clocking cable (CC) (710) are not shown in FIG. 9 (or, as stated, in some embodiments, a clocking cable CC) is not included). Further, consistent with the definition of an AOC, FIG. 9A depicts an electrical-optical interface (902) disposed at a terminal end (and may be considered part of) the first reception cable (901) and first transmission cable (903). In FIG. 9A, the data cable assembly (700) is terminated with a connector (904). The connector (904) is configured to mate and/or interface with a complementary connector (not shown) of the control board (901). The connector (904) may be a standard USB-C connector to accommodate existing interfaces on the control board (901) or the connector (904) may be specific to the data cable assembly itself providing only pin connections for the cables of the data cable assembly. FIG. 9B depicts a sectional view of a connector (904) of the latter type (i.e., specific to the depicted data cable assembly). As seen in FIG. 9B, the connector (904) can provide connection pins (906) for easy interfacing of the cables of the data cable assembly with the control board (901). In FIG. 9B, only four connection pins (906) are depicted, however, more connection pins (906) may be present to accommodate the cables of the data cable assembly (700) (i.e., the cables included in the data cable assembly but not shown, for concision, in FIG. 9A). Moreover, in some instances, the connector (904) has an asymmetrical profile, for example, with a protrusion (908) to ensure that the data cable assembly (700) can only interface and/or mate with the control board (901) according to a particular orientation of the connector (904) relative to a complementary connector profile of the control board (901). In some cases, the clocking functionality is performed mechanically using the connector.

In summary, the power cable assembly and data cable assembly disclosed herein have improved fatigue life over currently-employed electrical cables enabling tighter bend radii and smaller robotic links and joints.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A robotic arm, comprising:
a base;
a master control board;
a first joint coupled to the base;
a first link, wherein a proximal end of the first link is moveably connected to the first joint;
a first control board configured to control the first joint;
a first data cable assembly, comprising:
a first data transmission cable,
a first power cable comprising a first plurality of cladded wires, and
a first ground cable comprising a second plurality of cladded wires; and
wherein a proximal end of the first data cable assembly is communicatively connected to the master control board, the first data cable assembly is positioned to articulate with the first joint, and a distal end of the first data cable assembly is communicatively connected to the first control board.

2. The robotic arm of claim 1, further comprising:
a first power terminal disposed in one of the first link and the first joint;
a first power cable assembly, comprising:
a first high power cable comprising a third plurality of cladded wires, and
a first high power grounding cable comprising a fourth plurality of cladded wires;
wherein a proximal end of the first power cable assembly is electrically coupled to a power source, the first power cable assembly is positioned to articulate with the first joint, and a distal end of the first power cable assembly is electrically connected to the first power terminal.

3. The robotic arm of claim 2, wherein each cladded wire in the first, second, third, and fourth pluralities of cladded wires comprises a tungsten wire cladded with copper.

4. The robotic arm of claim 1, wherein the first data cable assembly further comprises:
a second power cable comprising a fifth plurality of cladded wires; and
a second ground cable comprising a sixth plurality of cladded wires.

5. The robotic arm of claim 2, wherein the first power cable assembly further comprises:
a second high power cable comprising a seventh plurality of cladded wires, and
a second high power grounding cable comprising an eighth plurality of cladded wires.

6. The robotic arm of claim 1, wherein the first data transmission cable is a first active optical cable comprising:
an optical fiber cable;
a first electrical-optical converter disposed at a proximal end of the optical fiber cable; and
a second electrical-optical converter disposed at a distal end of the optical fiber cable,
wherein each of the first and second electrical-optical converters converts received electrical signals to optical signals and converts received optical signals to electrical signals.

7. The robotic arm of claim 1, further comprising:
a first connector that terminates the proximal end of the first data cable assembly, the first connector configured to connect to the master control board; and
a second connector that terminates the distal end of the first data cable assembly, the second connector configured to connect to the first control board.

8. The robotic arm of claim 1, further comprising:
a second joint connected to a distal end of the first link;
a second link, wherein a proximal end of the second link is connected to the second joint;
a second control board configured to control the second joint and a second power terminal disposed in one of the second link and the second joint;
a second data cable assembly, comprising:
a second data transmission cable,
a third power cable comprising a ninth plurality of cladded wires, and
a third ground cable comprising a tenth plurality of cladded wires; and
a second power cable assembly, comprising:
a third high power cable comprising an eleventh plurality of cladded wires, and
a third high power grounding cable comprising a twelfth plurality of cladded wires,
wherein a proximal end of the second data cable assembly is communicatively connected to the first control board, the second data cable is positioned to articulate with the second joint, and a distal end of the first data cable assembly is communicatively connected to the second control board,
wherein a proximal end of the second power cable assembly is electrically connected to the first power terminal, the second power cable assembly is positioned to articulate with the second joint, and a distal end of the second power cable assembly is electrically connected to the second power terminal.

9. The robotic arm of claim 8,
wherein the first high power cable and the first high power grounding cable have a first gauge,
wherein the third high power cable and the third high power grounding cable have second gauge, and
wherein the second gauge is greater than the first gauge.

10. The robotic arm of claim 4, wherein:
the first power cable and second ground cable form a first pair;
the second power cable and the second ground cable form a second pair;
the first data cable assembly further comprises:
a third power cable and a third ground cable forming a third pair and each comprising a plurality of cladded wires,
a fourth power cable and fourth ground cable forming a fourth pair and each comprising a plurality of cladded wires, and
a clocking cable;
wherein every cable in the first data cable assembly is disposed on a plane such that a cross-sectional profile of the first data cable assembly is rectangular or ribbed,
wherein the first data transmission cable and the clocking cable bound a center of the first data cable assembly and the first and second pair are disposed adjacent to the first data transmission cable and the third and fourth pair are disposed adjacent to the clocking cable.

11. The robotic arm of claim 4, wherein:
the first data transmission cable is disposed at an axial center of the first data cable assembly;
the first data cable assembly further comprises:
a third power cable and a third ground cable each comprising a plurality of cladded wires,
a fourth power cable and fourth ground cable each comprising a plurality of cladded wires,
a clocking cable,
a flexible filler layer forming an annulus and disposed concentrically about the first data transmission cable, and
a ring of cables disposed concentrically about the flexible filler layer, consisting of:
the first, second, third, and fourth power cable;
the first, second, third, and fourth ground cable; and
the clocking cable.
